(19) United States
(12) Patent Application Publication
(10) Pub. No.: US 2004/0111942 A1
(43) Pub. Date: Jun. 17, 2004

(54) Information tag

(76) Inventor: Shaazia Stonehocker, Conroe, TX (US)

Correspondence Address: FULBRIGHT & JAWORSKI, LLP, 1301 MCKINNEY, SUITE 5100, HOUSTON, TX, 77010-3095, US

(21) Appl. No.: 10/702,866

(22) Filed: Nov. 6, 2003

Related U.S. Application Data
(60) Provisional application No. 60/423,962, filed on Nov. 6, 2002.
(60) Provisional application No. 60/456,372, filed on Mar. 21, 2003.

(51) Int. Cl. G09F 3/18

(52) U.S. Cl. 40/661.06

(57) ABSTRACT

An emergency information tag is provided that is designed for toddlers or individuals with reduced capacity to communicate and intended to provide contact or other information on a writing surface. The tag has a clamshell configuration and is adapted such that it is easily attached to a shoe, stroller, backpack, or article of clothing.

### CROSS-REFERENCE TO RELATED APPLICATIONS

This application claims priority to U.S. Provisional Application No. 60/423,962, which was filed Nov. 6, 2002, and to U.S. Provisional Application No. 60/456,372, which was filed Mar. 21, 2003, which are hereby incorporated by reference in their entireties.

### TECHNICAL FIELD

This invention relates to safety. Specifically, it relates to an information tag intended to provide emergency contact, medical information, or identification information about a child, an individual with reduced capacity to communicate, or an injured person.

### BACKGROUND OF THE INVENTION

Toddlers, by nature, are curious and like to explore. At times, they may wander away from their parent/guardian and become lost in a public place such as a shopping mall, grocery store or park. In emergency situations, communicating vital information such as a phone number or full name can be difficult for a young or injured child. Various attempts have been made to address these problems in the past. There are currently many different forms of information employed in an effort to provide identification in an emergency. U.S. Pat. No. 5,312,136 discloses a shoe identification tag designed to fit inside the sole of a person's shoe. The ID tag provides medical information about the wearer in the case of an emergency, and is simply a paper record of a person's identification and medical record. This form of identification is not intended for very young children or toddlers. The placement of this identification tag is not intuitive and, in the case where the child is lost, it can easily be overlooked. In addition, in emergency situations, looking for identification inside the shoe is not practical. This tag does not draw the attention of those providing assistance and, therefore, does not solve the problem for small toddlers.

U.S. Pat. No. 5,195,783 discloses an identification tag made from a flexible strip of textile, plastic or other suitable material that is adapted to be wrapped about the shoelaces. This tag is limited in space and can pose a challenge to informing firefighters and paramedics of its use. In addition, this tag also poses a choking hazard for a young child who is able to remove it from their shoe. Many parents use ribbons to accessorize their child's wardrobe, therefore, this tag can easily be mistaken for an accessory and overlooked. U.S. Pat. No. 6,042,005 discloses a personal identification system for children that includes two forms of identification. An identification card carried by the user contains the user's personal identification information in an electronic medium. This tag is not intended for small toddler-aged children who do not have a method for carrying this identification tag (such as a purse or wallet). In addition, this tag is not easily noticed in the case of an emergency.

U.S. Pat. No. 5,454,600 discloses a personal identification tag that is in the form of an iron-on label. It contains a special fingerprint receiving area that is designed to include a fingerprint of a child. This tag does not include contact or medical information about the child and, therefore, does not provide identity, medical alerts, or contact information immediately in an emergency situation. Tags that fit around the child's neck or on their wrist can be easily removed by toddlers or break when the child is at play. In addition, these tags are typically made of metal and require direct contact with the child's skin posing an allergy or irritant risk. They are typically not intended for children under the age of 3, and pose a choking hazard. Tags of this type usually require engraving and, therefore, are not easily modifiable as contact information changes. Furthermore, if the information on the tag becomes outdated, a time lag is possible before the parent/guardian orders and receives an updated tag, therefore leaving the child without any identification for period of time.

There exists a need for an emergency information tag that is designed specifically for a toddler or other individual with reduced ability to communicate, such as an elderly person or persons with special needs such as those with mental infirmities who are unable to identify themselves either verbally or in writing or communicate to others information about themselves. Included within this group are, for example, pre-verbal children, preschool and some school age children, children and adults with syndromes such as Down Syndrome, adults with neurologic conditions such as Alzheimer disease, and the like.

All patents and publications mentioned in the specifications are indicative of the levels of those skilled in the art to which the invention pertains. All patents and publications are herein incorporated by reference to the same extent as if each individual publication was specifically and individually indicated to be incorporated by reference.

### BRIEF SUMMARY OF THE INVENTION

An embodiment of the present invention is an information tag comprising a top and a base having inside and outside surfaces, a writing surface on the inside surface of the top or base; a hinge connecting the top and base; and a latch configured to secure the top and base together when engaged, whereby the writing surface is not visible when the latch is engaged.

In a specific embodiment, the invention further comprises flexible straps adapted to snap or thread into the base. In another embodiment, the tag further comprises lace holes or strap holes.

In another specific embodiment, the tag further comprises grip nubs. In another specific embodiment, the tag further comprises a viewing window.

In one specific embodiment of the invention, the writing surface comprises non-toxic paint, vinyl, a decal, or a sticker.

In one specific embodiment of the invention, the tag further comprises a side cutout. In one specific embodiment of the invention, the hinge is a living hinge. In another embodiment, the hinge is an assembled hinge.

In a specific embodiment, the invention further comprises an emergency identifier region for displaying emergency information.

In a specific embodiment, the invention further comprises a decorative image on a portion of the tag. In one embodiment, the image is raised.

In a specific embodiment, the invention further comprises polypropylene (PP), Polyethylene (PE), Acrylonitrile Butadiene Styrene (ABS), or vinyl.

An embodiment of the invention is a nontoxic information tag comprising: a top and base having an inside and outside surface, wherein a portion of the outside surface of the top or base comprises an emergency identifier region; means for displaying information of desired content on the inside surface of the top or base; hinge means; and fastening means.

An embodiment of the invention is an information tag comprising: a top and base having an inside and outside surface; a writing surface on the inside surface of the top or base; a hinge; and a latch; whereby the information tag is adapted for attachment to an object.

In a specific embodiment, the object is a shoe. In a specific embodiment, the object is a stroller, backpack, lunchbox, luggage, car seat, or article of clothing.

In an embodiment of the invention, the information tag has a clamshell configuration. In a specific embodiment, the top and base have an essentially hourglass, circular, rectangular or ovular shape. In another embodiment of the present invention, the tag is non-toxic or hypoallergenic. In yet another embodiment, the tag is designed to meet safety standards for children under the age of 3.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings.

FIG. 1 shows an outside plan view of an open tag;

FIG. 2 shows a inside plan view of the tag of FIG. 1;

FIG. 3 shows a perspective view of a closed tag of FIG. 1;

FIG. 4 shows a side plan view of the tag of FIG. 1;

FIG. 5 shows a perspective view of the closed tag of FIG. 3 attached to a phantom strap;

FIG. 6 shows a perspective outside view of another embodiment of a tag with flexible straps and pin attachments.

FIG. 7 shows a perspective outside view of another embodiment of a tag with flexible straps and threading openings; and

FIG. 8 shows a perspective view of another embodiment of a tag in a closed position with protruding lace or strap holder.

### DETAILED DESCRIPTION OF THE INVENTION

It is readily apparent to one skilled in the art that various embodiments and modifications can be made to the invention disclosed in this Application without departing from the scope and spirit of the invention.

As used herein, the use of the word “a” or “an” when used in conjunction with the term “comprising” in the sentences and/or the specification can mean “one,” but it is also consistent with the meaning of “one or more,” “at least one,” and “one or more than one.”

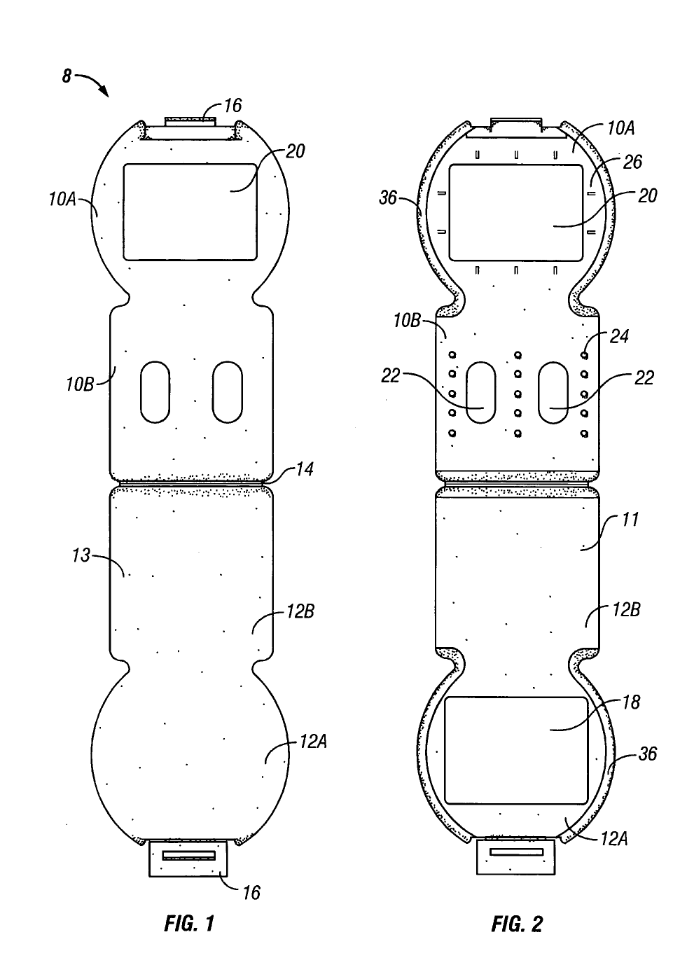

In a first embodiment of the invention, the present invention is related to a “tag” or an “information tag” 8, which is a device adapted for attachment to a variety of objects. The tag 8 is preferable in a clamshell configuration. The tag 8 comprises a top 12, having a first portion 12A and a second portion 12 B and base 10, having a first portion 10A and a second portion 10 B. The tag 8 is connected by a hinge or hinge means 14 positioned between the second portions 10B, 12B of the base 10 and top 12. The tag 8 has an an inside 11 and outside 13. In a preferred embodiment, the first portions 10A and 12A are generally circular in shape and the second portions 10B and 12B are generally rectangular in shape. The tag 8 also comprises a latch, fastening, closing, or latching means 16 positioned on the first and second portions 10A, 12A of the base 10 and top 12. See FIG. 1. The tag 8 also comprises a writing surface 18 or means for displaying information of any desired content that can be on the inside 11 of the first portions 10A, 12A of the top 12 or base 10. Two lace holes 22 are preferably located on the second portion 10B of base 10. A plurality of grip nubs 24 can surround the lace holes 22. See FIG. 2. It is further contemplated that the grip nubs 24 can be placed on either the second portions 10B, 12B of the top 12 or base 10, and are merely depicted on the base 10 for illustrative purposes. A viewing window 20 can be located on first portion 10A of base 10 and can be surrounded by a plurality of support ribs 26.

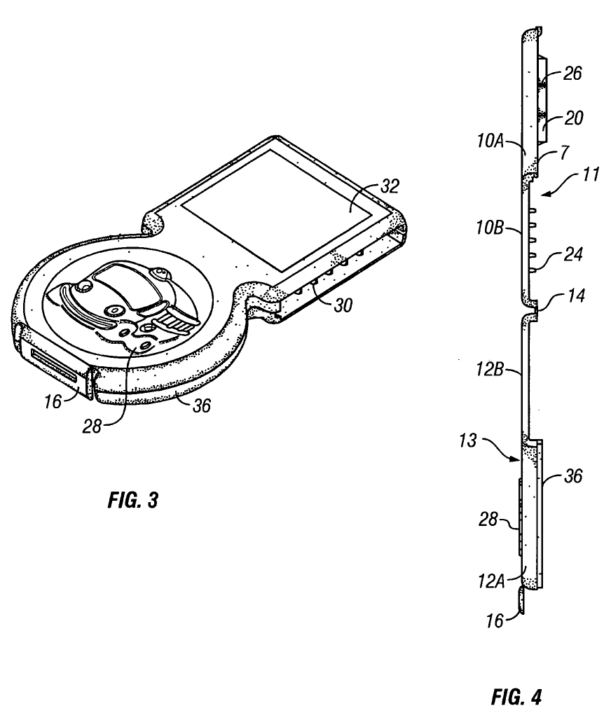

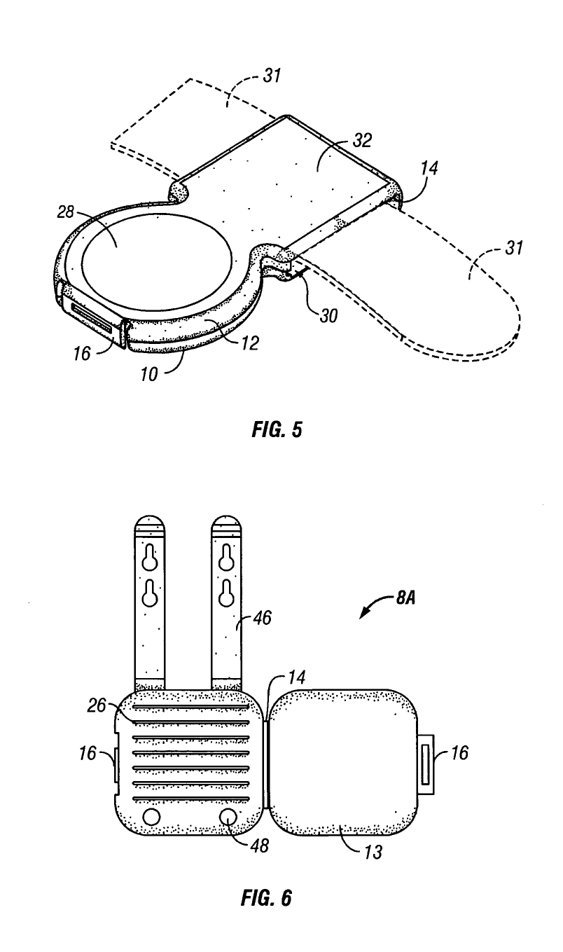

In one aspect, the tag 8 can display an emergency identifier or text on region 32 positioned on top portion 12B indicating that the tag 8 contains emergency information. The tag 8 also can display a decorative image 28 located on top portion 12A of the outside of the base 10. Alternately, the placement of the emergency text and decorative image 28 can be reversed. The top 12 and base 10 also include short side walls 36 or lips extending around the outer edges of the top first portion 10A and the base first portion 12A, such that when the tag 8 is closed, the side walls 36 of the top portion 12A and base portion 10A meet. See FIGS. 2, 3. The side walls 36 are discontinuous, forming a side cutout 30 between the top portion 12B and the base portion 10B of the tag 8 such that the tag 8 can be closed over a strip of clothing or shoe strap 31 See FIGS. 3, 5. When the tag 8 is in the closed configuration, the outside of the top portions 12A and B are in an upright position, allowing viewing of the text on region 32 and the decorative image 28. Turning the closed tag 8 around, allows viewing of the writing surface 18 through the viewing window 20. When the tag 8 is in the open configuration, the writing surface 18 and grip nubs 24 are visible. See FIG. 4.

In a second embodiment of the invention, a tag 8A comprises a base 10, a top 12, a hinge 14, and a latch 16. The tag 8A is secured on a desired object through the use of flexible straps 46 located on one side of the base 10 that snap into pins 48 located on the base 10 opposite the straps 46. The tag 8A also comprises support ribs 26 located on the outside surface 13A of the base 10. See FIG. 6.

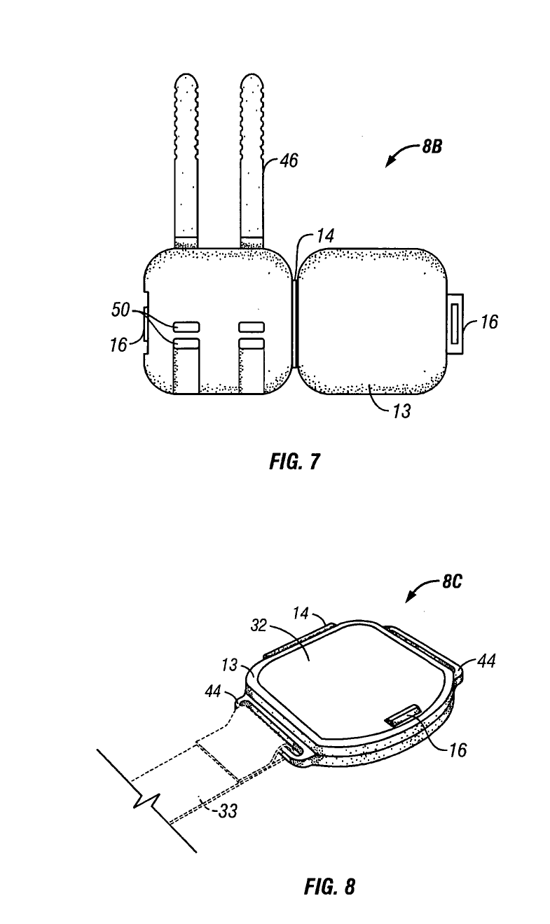

In a third embodiment of the invention, a tag 8B comprises a base 10, a top 12, a hinge 14, and a latch 16. The tag 8B is secured on a desired object through the use of flexible straps 46 located on one side of the base 10 that are configured to be threaded through openings 50 in the base 10. See FIG. 7.

In a fourth embodiment of the invention, a tag 8C comprises a base 10, a top 12, a hinge 14, and a latch 16., Tag 8C is secured on a desired object, such as a strip of material 33, through the use of a pair of lace or strap holders 44 in parallel alignment, that protrude from both sides of the tag 8 C top 12 or base 10. The tag 8C also can include an emergency identifier or text on region 32. The tag 8C is illustrated in a closed position and the region 32 can be placed on either the outside of the base 10 or top 12. See FIG. 8.

Preferably, a writing surface 18 or means for displaying information of any desired content is on an inside surface of the tags 8A, B and C.

As described above, all of the above embodiments include a hinge 14 or hinge means, which can be any hinge appropriate for use in the present invention. Examples of such hinges are living hinges, assembled hinges, pin hinges, or snap-together hinges. A “living hinge,” as it is well known in the plastic and toy manufacturing arts, is a neck-down or thin section of plastic material that has a minimal amount of plastic memory or “set” relative to its designed direction of rotation or flexing. The neck-down or thin section of the plastic is relatively free of stresses and is capable of a large number of flexing operations well within the normal life of the plastic article in which it is used.

As described above, all of the above embodiments include a latch or fastening, closing or latching means 16. Examples of fastening, closing, or latching means are latches, clasps, snaps, pins, clips, ties, screws, hook and eyes, rivets, and buckles. The connection can be reversible or irreversible. If the latch or fastening, closing, or latching means 16 is reversible, the tag 8 can be opened and reused over and over. Alternatively, the fastening, closing, or latching means 16 can be irreversible, such that the tag 8 can only be closed once, and must be cut open to view the information displayed on the writing surface 18. The latch 16 or fastener can be described as being “closed,” or “engaged,” or “in operation” to indicate that the latch or fastener 16 is actively connecting the top 12 and base 10 of the tag 8. One with skill in the art realizes that a closed latch or fastener is reasonably secure, such that a toddler at play or a runner can engage in normal activity without fear of opening or disengaging the latch or fastener. When the connection is broken, such that the hinge 14 can be freely operated and the writing surface 18 is easily visible upon rotating the tag top about the hinge 14, the latch 16 or fastener is described as “disengaged” or “open.” It is contemplated that the closing, latching, or fastening can also act to secure the tag on a desired object, such as a shoe or stroller.

In all of the above embodiments, the tag 8 closes to conceal information displayed on the inside writing surface 18 from bystanders and opens to display the information. It is contemplated that the writing surface 18 or other means for displaying information of desired content can be located on the inside 11 of tag 8, in either of the first portions 10A or 12A. If tag 8 is configured as in FIGS. 6, 7 or 8, the writing surface 18 can be on the inner surface of either the base 10 or top 12. It is contemplated that the writing surface can be a painted surface, a non-toxic painted surface, a decal, a sticker, a plastic or vinyl surface, or a paper surface. It is contemplated that the writing surface 18 can be written upon using a pen, a pencil, or a marker. It is also contemplated that the writing surface 18 can be adapted for the display of Braille characters. The information of any desired content can be medical information, allergy information, contact information, encoded information, or emergency information. One with skill in the art realizes that the information to be displayed is not limited to the above.

Any of the above embodiments can comprise an emergency identifier located in region 32. The emergency identifier can be text, such as “Emergency Information,” or a symbol, such as a Caduceus symbol, or a combination of both. If tag 8 includes an emergency identifier, it is clearly depicted on the tag 8 such that it is easily discernable to one viewing the tag 8 during its normal operation. It is contemplated that the emergency identifier region 32 is depicted on the outside 13 of the top portion 12B. If the emergency identifier information located in region 32 is text, the size and type of text is such that the text can be easily read by an individual with normal or corrected vision from a distance of about 12 inches. It is contemplated that the text of the emergency identifier information is easily adapted to be recognized by people who speak a variety of languages. It is also contemplated that the emergency identifier information is easily adapted to relate to the user of the tag, such as an adult or a toddler.

In certain embodiments of the invention, the tag 8 includes a child-friendly image 28 easily visible on the tag 8 to appeal to small children. Such an image can be a raised, or proud, image. The tag 8 can be manufactured in a variety of designs and colors and can, therefore, serve as a decorative accessory as well as a functional information tag.

In any of the above embodiments of the invention, it is contemplated that the tag 8 is made of a non-toxic material. Such materials include polypropylene (PP), Polyethylene (PE), Acrylonitrile Butadiene Styrene (ABS), or vinyl. It is also contemplated that the tag 8 does not require direct contact with a user's skin, thus reducing the risk for possible allergic reactions.

In any of the above embodiments, it is contemplated that the base 10 and top 12 can comprises an hourglass shape, an oval shape, a rectangular shape, a circular shape, or a square shape. It is also contemplated that the shape of the base 10 and top 12 can be symmetrical or asymmetrical. By hourglass shape, it is meant that the top 12 and base 10 comprise two distinct shapes, which can be the same or different, and which are joined at a central region that is narrower in width than the two shapes of the top and base. For example, an hourglass shape can comprise two circular shapes joined at a narrower central region. In certain embodiments, a substantially hourglass shape can comprises a square shape joined to a circular shape at a narrower central region.

In certain embodiments of the invention, it is contemplated that the tag 8 is for use in providing information about a toddler, an injured person, or other individual with reduced ability to communicate. An example of these individuals would be an elderly person, or persons with special needs such as those with mental infirmities who are unable to identify themselves either verbally or in writing, or other persons who cannot communicate to others information about themselves. Included within this group are, for example, pre-verbal children, preschool and school age children, children and adults with syndromes such as Down Syndrome, adults with neurologic conditions such as Alzheimer disease, and the like. It is also contemplated that the present invention can be appropriate for use by joggers, bikers and other athletes who may wish to have identifying information or medical information on their person while they exercise.

The tag 8 can be adapted to fit on many different types and sizes of shoes such as those comprising laces, hook and loop fastener straps, or sandals. In addition, the tag 8 can be attached to a backpack, car seat, stroller, luggage, or purse. It is contemplated that the tag 8 of the present invention is simple and easy to attach onto a child's shoe, car seat, stroller, backpack, lunchbox, or luggage. It is contemplated that the invention is appropriate for attachment to shoelaces, Velcro™ straps, or similar strips of material.

In certain embodiments, the tag 8 meets safety standards for choking and toxicity for children under the age of 3, and can be used by older children as well. It is contemplated that the tag 8 is manufactured out of durable, non-toxic materials, such as plastic, and is not easily broken by a toddler at play. It is contemplated that the tag 8 stays in place, is durable, and is easily identifiable as a device for providing information in the case of an emergency.

It is also contemplated that the tag 8 can be adapted to contain a printed circuit or chip suitable for radio frequency information. Upon receiving a transmitted signal from a transmitter held by a guardian or parent, the tag 8 is energized, thereby causing it to generate a light or sound signal.

The method of manufacturing the foregoing product is substantially such that it can be formed from an injected molded plastic. The plastic can be in the form of polypropylene or any other suitable equivalent, such as polymers that have the flexibility and general equivalent resiliency of polypropylene when in the configuration in which it is formed.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An information tag comprising:
a top and a base having inside and outside surfaces,
a writing surface on the inside surface of the top or base;
a hinge connecting the top and base; and
a latch configured to secure the top and base together when engaged, whereby the writing surface is not visible when the latch is engaged.

2. The information tag of claim 1, further comprising flexible straps adapted to snap or thread into the base.

3. The information tag of claim 1, wherein the tag further comprises lace holes.

4. The information tag of claim 1, wherein the tag further comprises grip nubs.

5. The information tag of claim 1, wherein the tag further comprises a viewing window in a portion of the tag.

6. The information tag of claim 1, wherein the writing surface comprises non-toxic paint, vinyl, a decal, or a sticker.

7. The information tag of claim 1, wherein the tag further comprises a side cutout.

8. The information tag of claim 1, wherein the hinge is a living hinge or an assembled hinge.

9. The information tag of claim 1, further comprising an emergency identifier region for displaying emergency information.

10. The information tag of claim 1, further comprising a decorative image on a portion of the tag.

11. The information tag of claim 10, wherein the image is raised.

12. The information tag of claim 1, wherein the tag comprises polypropylene (PP), Polyethylene (PE), Acrylonitrile Butadiene Styrene (ABS), or vinyl.

13. A nontoxic emergency information tag comprising:
a top and base having an inside and outside surface, wherein a portion of the outside surface of the top or base comprises an emergency identifier region;
means for displaying information of desired content on the inside surface of the top or base;
hinge means; and
fastening means.

14. An information tag comprising:
a top and base having an inside and outside surface;
a writing surface on the inside surface of the top or base;
a hinge; and
a latch;
whereby the information tag is adapted for attachment to an object.

15. The information tag of claim 14, wherein the object is a selected from a group consisting of a shoe, stroller, backpack, luggage, car seat, lunchbox, and article of clothing.

16. The information tag of claim 14, wherein the information tag has a clamshell configuration.

17. The information tag of claim 14, wherein the top and base have an essentially hourglass, circular, rectangular or ovular shape.

18. The information tag of claim 14, wherein the tag is non-toxic or hypoallergenic.

19. The information tag of claim 14, wherein the tag is designed to meet safety standards for children under the age of 3.
